(19) United States
(12) Patent Application Publication
(10) Pub. No.: US 2009/0055051 A1
(43) Pub. Date: Feb. 26, 2009

(54) METHOD OF DETERMINING WHETHER TO DEPLOY AIRBAGS

(76) Inventor: Sang Uk Chu, Hwaseong-si (KR)

Correspondence Address: MORGAN, LEWIS & BOCKIUS LLP (SF), One Market, Spear Street Tower, Suite 2800, San Francisco, CA, 94105, US

(21) Appl. No.: 11/942,532

(22) Filed: Nov. 19, 2007

(30) Foreign Application Priority Data
Aug. 22, 2007 (KR) 10-2007-0084457

(51) Int. Cl. G05D 3/14; G06F 17/00

(52) U.S. Cl. 701/45; 701/96

(57) ABSTRACT

A method of determining whether to deploy airbags includes measuring the distance between a vehicle and a forward obstacle; selecting a deceleration threshold value depending on the distance; and if the deceleration of the vehicle is greater than the deceleration threshold value, determining that the airbags should be deployed. The distance may be measured using a radar sensor of an adaptive cruise control system. The deceleration threshold value may be a small value if the distance is small, and a larger value if the distance is larger. Selecting the deceleration threshold value may include comparing the distance with at least one preset distance, selecting a small deceleration threshold value if the distance is smaller than the preset distance, and selecting a large deceleration threshold value if the distance is greater than or equal to the preset distance.

### CROSS-REFERENCE TO RELATED APPLICATIONS

This application claims priority to Korean Application No. 10-2007-0084457, filed on Aug. 22, 2007, the disclosure of which is incorporated herein by reference.

### BACKGROUND OF THE INVENTION

1. Field of the Invention

The present invention relates to a method of determining whether to deploy airbags that selects a threshold deceleration value based on the distance between a vehicle and a forward obstacle.

2. Description of the Related Art

A typical Airbag Control Unit (ACU) diagnoses whether an airbag system is functioning normally when the vehicle is running. When a vehicle collision is detected, the ACU executes an airbag deployment algorithm, thereby determining whether to deploy airbags, and subsequently deploys them.

Typical threshold deceleration values for executing the airbag deployment algorithm are about 3 (where g is acceleration due to gravity), and vary slightly depending on the manufacturer.

The time from when the airbag deployment algorithm starts to be executed to the time when the airbag deployment signal is output is approximately 10 to 20 ms. The airbag deployment signal should be output within 6 to 8 ms in the case of a side collision, and times as little as 1 ms may cause differences in the extent of injuries to passengers. Because the threshold deceleration value is fixed, airbags are often deployed late, particularly in high-speed collisions.

In addition, many modern vehicles include Adaptive Cruise Control (ACC) technology, which detects the distance to a forward vehicle,⁵⁰ using radar, to maintain the desired distance between vehicles. This technology has not yet been used in airbag deployment algorithms.

### SUMMARY OF THE INVENTION

A method of determining whether to deploy airbags includes measuring the distance between a vehicle and a forward obstacle; selecting a deceleration threshold value depending on the distance; and if the deceleration of the vehicle is greater than the deceleration threshold value, determining that the airbags should be deployed.

The distance may be measured using a radar sensor of an adaptive cruise control system.

The deceleration threshold value may be a small value if the distance is small, and a larger value if the distance is larger.

Selecting the deceleration threshold value may include comparing the distance with at least one preset distance, selecting a small deceleration threshold value if the distance is smaller than the preset distance, and selecting a large deceleration threshold value if the distance is greater than or equal to the preset distance.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a flowchart showing an airbag deployment method according to an embodiment of a present invention;

FIG. 2 is a flowchart showing an example of a method of selecting a threshold value;

FIG. 3 is a view showing the selection of the threshold value depending on the measured distance value shown in FIG. 2; and

FIG. 4 is a view illustrating gain acquired depending on the threshold value.

### DESCRIPTION OF THE PREFERRED EMBODIMENTS

Reference now should be made to the drawings, in which the same reference numerals are used throughout the different drawings to designate the same or similar components.

A method of determining whether to deploy airbags according to a preferred embodiment of the present invention will be described with reference to the accompanying drawings below.

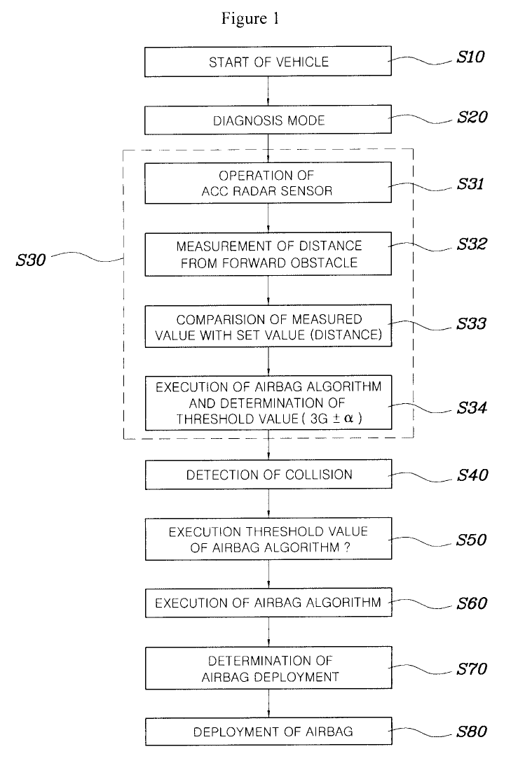

Referring to FIG. 1, after a vehicle is started at step S10, an Airbag Control Unit (ACU) diagnoses whether the airbag system is functioning normally at step S20. After determining an appropriate deceleration threshold value for executing an airbag deployment algorithm at step S30 (which will be described in detail below), if a vehicle collision is detected at steps S40, the ACU executes an airbag deployment algorithm at step S60 under the condition that vehicle deceleration is greater than the deceleration threshold value at step 50. And, if the vehicle deceleration attributable to the collision is equal to or greater than a predetermined threshold value, the ACU determines that the airbags should be deployed at step S70, and then the airbags are deployed at step S80.

Determining the appropriate deceleration threshold value at step S30 is as follows. After the start of the vehicle, a radar sensor, such as that included in an Adaptive Cruise Control (ACC) system, is operated at step S31. The distance between the vehicle and a forward obstacle is then measured at step S32. The measured distance is compared with one or more distance threshold values at step S33. The deceleration threshold value is determined, based on the result of step S33, at step S34. Step S34 sets a small deceleration threshold value if the distance measure at step S32 is small, and a large deceleration threshold value if the distance is large.

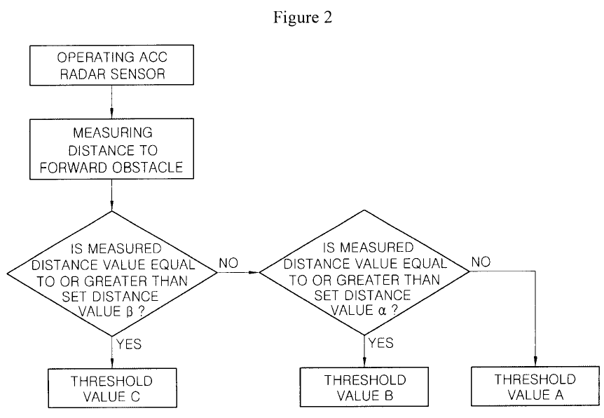

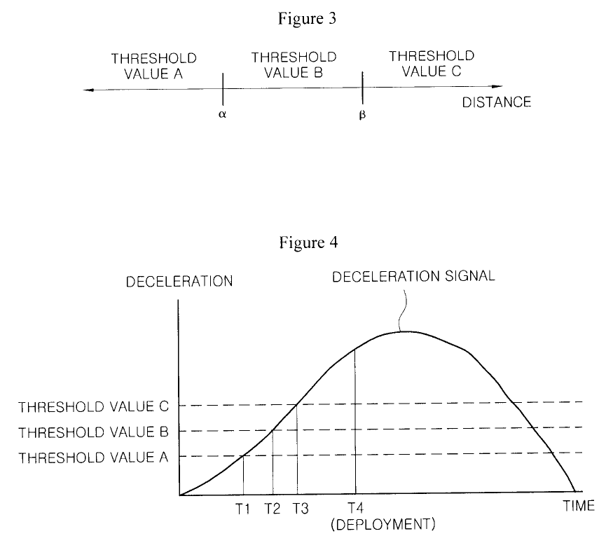

The deceleration threshold value may be determined as shown in FIGS. 2-3. The radar sensor is operated, and the distance between the vehicle and a forward obstacle is measured. The value of the measured distance is transmitted to the ACU, and the measured distance is compared with preset distance threshold values. In the illustrated embodiment, there are two such values, referred to as α and β. The measured distance is compared with the set distances α and β, and then the deceleration threshold value is selected as either A, B, or C.

As shown in FIG. 3, if the measured distance is smaller than α, i.e. the distance between the vehicle and a forward obstacle is small, the deceleration value is set to A. If the measured distance is greater than or equal to β, i.e. a large distance, the deceleration threshold value is set to C. If the measured distance is greater than or equal to α but less than β, the deceleration threshold value is set to B. In this example, A<B<C. That is, the smaller the measured distance, the smaller the deceleration threshold value.

Of course, there is some variation over time in the actual distance between the vehicle and the forward obstacle. However, if the distance is measured by the radar at specific, discrete intervals, the measured distance is fairly accurate.

In the foregoing description, it has been described that the deceleration threshold is smaller the shorter the distance between the vehicle and the forward obstacle. Referring to FIG. 4, when the measured distance is small, and the deceleration threshold is A, the time T1, at which the algorithm is executed, occurs earlier than at greater distances. If T4 is the time at which the airbags should be deployed, sufficient time is allotted to adjust the time until the airbags are deployed.

According to the inventive method of determining whether to deploy airbags, since the time at which the airbag deployment algorithm is executed varies depending on the distance between the vehicle and the forward obstacle measured before a collision, sufficient time is allotted to determine whether to deploy the airbags, and to deploy them.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A method of determining whether to deploy airbags, comprising:
measuring a distance between a vehicle and a forward obstacle;
selecting a deceleration threshold value for executing an airbag deployment algorithm depending on the distance;
executing the airbag deployment algorithm if a deceleration of the vehicle is greater than the deceleration threshold value; and
determining that the airbag should be deployed and deploying the airbag.

2. The method as set forth in claim 1, wherein the distance is measured using a radar sensor of an adaptive cruise control system.

3. The method as set forth in claim 1, wherein the deceleration threshold value is a small value if the distance is small, and a larger value if the distance is larger.

4. The method as set forth in claim 1, wherein the selecting the deceleration threshold value comprises:
comparing the distance with at least one preset distance; selecting a first deceleration threshold value if the distance is smaller than the preset distance; and
selecting a second deceleration threshold value if the distance is greater than or equal to the preset distance, wherein the second deceleration threshold value is larger than the first deceleration threshold value.
